(19) United States
(12) Patent Application Publication
(10) Pub. No.: US 2013/0268303 A1
(43) Pub. Date: Oct. 10, 2013

(54) METHOD AND SYSTEM TO HOST ELECTRONIC INTERACTIVE PASSENGER BOARDINGS

(71) Applicant: Rene Lawrence Messier, Calgary (CA)

(72) Inventor: Rene Lawrence Messier, Calgary (CA)

(21) Appl. No.: 13/440,999

(22) Filed: Apr. 6, 2012

(51) Int. Cl. G06Q 10/02; G06Q 50/30

(52) U.S. Cl. 705/5

(57) ABSTRACT

A method and system for determining, organizing, directing, displaying,and calling out a dynamic real time better boarding order of passengers by their assigned seats. The method includes the interactive participation of boarding passengers with a better boarding machine that hosts and directs the systematic progression of the better boarding order. The system accommodates and adjusts for passenger purchases at the gate, standby passengers and passengers who are late. The system also provides passengers with educational and entrainment videos, promotional videos and advertisements. A system machine for boarding passengers is also disclosed.

Embodiments of the present method and system relate to the airline industry but also generally relate to the entire field of commercial passenger transportation or any situation where pre assigned tickets are issued and people arrive at the same time, such as theaters, concerts et cetera.

### BACKGROUND OF THE METHOD AND SYSTEM

It is well established that airplanes only generate revenue when flying passengers to their destinations. Millions of people board commercial airlines everyday. 60% of consumer sentiment towards air travel in the US is negative and only 19% claim brand loyalty. Today's methods of boarding aircraft significantly contributes to the sentiment and lack of loyalty. Boarding times also contribute to the time needed to prepare the aircraft to safely depart and fly. Typically passengers are assigned reserved seating by row and position in the row. A number such as 30, 29, 28 usually depicts the rows and passenger position is depicted by letters such as A, B, C or the terms aisle, middle, center or window. However, the airlines fail to fully utilize and thus fully benefit on assigned reserved seating by row and position in the row, when boarding passengers. More efficient boarding of passengers will reduce airplane turn times and costs. Moreover, passenger anxiety, stress and confusion would be reduced. Crews would be able to better focus on boarding safety protocols and passenger service. Organizing and boarding passengers by their assigned seats will improve boarding efficiencies, increase passenger satisfaction, reduce airplane turn times and lower airline costs. Some tested studies claim boarding passengers by their assigned seats will improve turn times and save airlines millions of dollars every year. However, all studies conclude no system has yet been developed to overcome the complications boarding passengers by assigned seating is projected or claimed to create.

The inventor developed the idea while waiting to board an airplane. He realized most boarding procedures have gate crew announcing over the public address system the section, class or group in which passengers need to board the aircraft and fail to optimize the purpose of assigned seating. Current boarding procedures result in avoidable aisle and seat interference, which produces unnecessary gate and boarding stress, cabin anxiety and passenger frustration. Consequently, passengers often develop a sense of being disrespected by the airline. Other industries such as movie theaters have realized the importance of assigned seating and now offer the sale of assigned seats and honoring assigned seating with preferred access. Also, the elevator industry has adopted systems that efficiently direct riders in lobbies to elevators that service a section of floors in the building. Elevators are programmed to avoid having multiple elevators delivering passengers to the same floors at the same time. The result is a 40+% reduction in vehicle wear and tear. If other industries have recognized the benefits of organizing riders or optimizing the purpose of assigned seating, it's time for the passenger transportation industry to implement a new method and system.

Many studies indicate improved boarding of passengers would dramatically improve airline turn times and reduce airline costs. One tested study actually demonstrates how one method of boarding by assigned seats can reduce the occupying of the airplane by 50% . Therefore, airlines would benefit from new optimal methods that organize and direct the efficient boarding of passengers by their assigned seats to reduce plane turn times and improve passenger satisfaction.

The method invented to solve the problem is called a Better Boarding Order™ The invented system and machine that implement and direct the solution are called a Better Boarding System' and Better Boarding Machine™

### PRIOR ART

The following discussion is to identify prior art exists. A description of each reference is provided followed by a brief explanation as to how the present method and system distinguishes the reference. All of the references address the boarding of passengers. The substantial distinguishing elements of the following references are; 1) None of the references direct the boarding of passengers in real time. 2) None of the references organize specific vehicle seating configurations with dynamic real time trip specific passenger data to produce a dynamic flight specific boarding order. 3) None of the references interact with boarding. 4) None of the references facilitate the real time dynamic organization and directing of boarding of passenger, by priorities and assigned seating. 5) None of the references provide an interactive boarding machine to direct. 6) None of the references engage or require the interaction of the boarding passengers. 7) None of the references engage the passengers to progressively activate the boarding of passengers by passenger assigned seats. 8) None of the references have a method to produce real time dynamic boarding orders to board both sides of the vehicle, rear to front, windows first, middle seats next and aisle seat last adjusting for passenger priorities and or passenger lateness

US Pat. Publication No. US 2007/0265890 discloses display plane seating configurations and the boarding of passengers in those configurations or small sections to be viewed in the gate lobby, terminals and check-in locations within a terminal. The display reflects the seating occupancy prior, during and after the boarding is complete. There is no organization of passengers to produce real improvement to the boarding process. Passengers can see the plane being occupied but fail to be seated by their assigned seat.

Differences: The main difference in the above patent application is the invention does not form part of a system to organize, display or direct the orderly interactive boarding elements required for participation of the passenger to progressively activate the interactive boarding of passengers. The above reference does not display interactive dynamic video education and entrainment of the passenger prior to boarding. The above reference does not display real time progression of passengers boarding order on a passenger assigned seating basis. Nor does the above reference facilitate the purchase of priority boarding privileges and other various services by passengers at the gate.

US Pat. Publication No. US 2005/0125266 discloses a method to assist airlines to determine the denied boarding of candidates utilizing financial data, passenger history and airline data at the gate in real time.

Differences: The main difference is the above mentioned application does not address the boarding of passengers onto the airplane. The invention addresses the organizing of passenger data to access deniability of passengers. This embodiment does not address the organizing, directing or boarding of cleared passengers.

US Pat. Publication No. US 2011/0166899 discloses a method to board passengers on flights according to bids.

Differences: The main difference is the above mentioned application does not address the boarding of passengers onto the airplane but rather facilitate the selling of seats and the boarding of those seats by bids to standby passengers. The embodiment does not use any method or system to improve the organizing or facilitating of the actual boarding process of the airplane.

US Pat. Publication No. US 2011/0137692 discloses a method to board passengers on flights according to valuation data.

Differences: The main difference is the above mentioned application does not address the boarding of passengers onto the airplane but rather facilitate the selling of seats and the boarding of those seats by valuation data (bids) to standby passengers. The embodiment does not use any method or system to improve the organizing or directing of the actual boarding process of the airplane.

U.S. Pat. No. 8,050,950 discloses a method to board passengers on flights according to passenger bids.

Differences: The main difference is the above mentioned application does not address the boarding of passengers onto the airplane but rather facilitate the selling of seats and the boarding of those seats by bids to standby passengers. The embodiment does not use any method or system to improve the organizing or directing of the actual boarding process of the airplane.

US Pat. Publication No. US 2006/0206353 discloses a method and system for intelligent queue management.

Differences: The main difference is the above mentioned application does provide specific methods or means of producing the claimed queue management. No structural or functional method of queuing or seating is revealed. Nor is programming detailed or computer programs explained to be delivered with any program specific equipment. No specific novel method or system is described to direct the boarding of passengers. Nor are real time dynamic plane and flight specific requirements addressed by this embodiment

US Pat. Publication No. US 2011/0178960 discloses a smart queuing method and system.

Differences: The main difference is the above mentioned application does not address the boarding of passengers onto the airplane but rather facilitate the queuing of customers for the restaurants, and venues No method is provided for organizing or direct larger groups of people in real time in an orderly manner. The embodiment is directed towards notifying customers of their place in the order of seating in the establishment.

US Pat. Publication No. US 2004/0162755 discloses an airport passenger processing and surface transportation system.

Differences: The main difference is the above mentioned application does not address the boarding of passengers onto the airplane but rather the transportation of passengers in pods with baggage through compatible airports. The embodiment addresses security handling issues and passenger movements.

US Pat. Publication No. US 2002/0193973 discloses a passenger moving and space system.

Differences: The main difference is the above mentioned application does not address the boarding of passengers onto the airplane but rather facilitate the complex movement of large groups of people in airports.

US Pat. No. 7,502,746 discloses a method and system for providing dynamic and real time air travel information.

Differences: The main difference is the above mentioned application does not address the boarding of passengers onto the airplane but rather provides passenger specific boarding information to standby passengers waiting to board. The embodiment focus is on clearing and informing standby passengers in real time at the gate. Remaining flight passengers are not guided or instructed in regards to the flight boarding process or procedure.

Article and Research by H. Van Landeghem and A Beuselinck. Aug. 9, 2001 is research into the problem and possible strategies of seating passenger. This research emphasizes the problem this invention solves. The real time organizing of passengers prior to entering the cabin at the gate in a method that will address flight and passenger specific needs while optimizing on the research findings. The research does not examine a combined method as this application delivers, integrating multiple methods into a dynamic, synchronized occupancy of both sides of the aircraft at the same time.

Article and Research by Piere Ferrari Jul. 31, 2004 is a re-examination of the Jandeghem and Beuselinck research and also examines the problem and possible strategies of seating passenger This research also emphasizes the problem this invention solves. The real time organizing of passengers prior to entering the cabin at the gate in a method that will address flight and passenger specific needs while optimizing on the research findings. The research does not examine a combined method as this application, integrating multiple methods into a dynamic synchronized occupancy of both sides of the aircraft at the same time.

Article by Jason Steffen 2008 Elsivier Publications, is an article that presents a novel method of having passengers board an airplane. The method presented significantly reduces time required to board an airplane. This embodiment boards passengers one side of the aircraft at a time. The embodiment neglects to address passenger lateness or requirements of passenger who wish to board as a couple. The article also emphasizes and does not address the need to organize passengers by priority, needs and airplane seating requirements prior to boarding in order for the benefits of this method to be of benefit. The method is not dynamic and does not address real time flight and passenger needs.

### BRIEF SUMMARY

A method as described herein configures and directs a real time better boarding order of an airplane and utilizes a dynamic interactive system to display and/or call out the real time better boarding order of passengers. The better boarding system allows airlines to implement and direct the real time better boarding order of passengers according to every flights unique real time circumstances and requirements. The system will determine, in real time, the most effective and efficient way to board passengers by their assigned seats, special needs, priorities relative to the plane's seating configuration and available entrance doors. The system then interacts with passengers to progressively direct the boarding of passengers to reduce conventional seat and aisle interferences. Reducing boarding congestion. Resulting in improved plane turn times, reduced airline costs and increased passenger satisfaction.

One embodiment is to board passenger on vehicles that transport passengers. Utilizing a dynamic interactive system to display and/or call out the real time better boarding order of passengers. The better boarding system allows vehicle operators to implement and direct the real time better boarding order of passengers according to every vehicle's unique real time circumstances and requirements. The system will determine, in real time, the most effective and efficient way to board passengers by their assigned seats, special needs, priorities relative to the vehicles' seating configuration and available entrance doors. The system then interacts with passengers to progressively direct the boarding of passengers to reduce conventional seat and aisle interferences, eliminate boarding congestion resulting in improved vehicle turn times and reduced operating costs.

One embodiment is to board passenger on ships that transport passengers. Utilizing a dynamic interactive system to display and/or call out the real time better boarding order of passengers. The better boarding system allows ship operators to implement and direct the real time better boarding order of passengers according to every voyage's unique real time circumstances and requirements. The system will determine, in real time, the most effective and efficient way to board passengers by their assigned seats, special needs, priorities relative to the ship's seating configuration and available entrance doors. The system then interacts with passengers to progressively direct the boarding of passengers to reduce conventional seat and aisle interferences, eliminate boarding congestion resulting in improved ship turn times and reduced costs.

One embodiment is to board passenger on spacecrafts that transport passengers. Utilizing a dynamic interactive system to display and/or call out the real time better boarding order of passengers. The better boarding order better boarding system allows spacecraft operators to implement and direct the real time better boarding order of passengers according to each flights unique real time circumstances and requirements. The system will determine, in real time, the most effective and efficient way to board passengers by their assigned seats, special needs, priorities relative to the craft's seating configuration and available entrance doors. The system then interacts with passengers to progressively direct the boarding of passengers to reduce conventional seat and aisle interferences, eliminate boarding congestion resulting in improved spacecraft turn times and reduced costs.

One embodiment is to board passenger on trains that transport passengers. Utilizing a dynamic interactive system to display and/or call out the real time better boarding order of passengers. The better boarding system allows train operators to implement and direct the real time better boarding order of passengers according to each every train's unique real time circumstances and requirements. The system will determine, in real time, the most effective and efficient way to board passengers by their assigned seats, special needs, priorities relative to the craft's seating configuration and available entrance doors. The system then interacts with passengers to progressively board passengers to reduce conventional seat and aisle interferences, eliminate boarding congestion resulting in improved train boarding times and reduced costs.

### BRIEF DESCRIPTION OF DRAWINGS

FIG. 1 is a diagram of an airport gate and boarding lobby as described in the embodiment.

FIG. 2 is a diagram depicting a variation of a better boarding order onto a single aisle, one door airplane.

FIG. 3 is a diagram depicting a variation of a better boarding order variation onto a single aisle two door airplane

FIG. 4 is a diagram of the system boarding machine and the layout of an embodiment of a better boarding order demonstrating how the machine interacts with the passengers to progressively activate the boarding order.

FIG. 5 is a diagram of the method utilized to build and facilitate an embodiment of a real time better boarding order.

FIG. 6 is a diagram of the rules utilized to build and facilitate an embodiment of a real time better boarding order.

FIG. 7 is a diagram depicting a variation of a better boarding order variation onto a two aisle, two door airplane.

FIG. 8 is a diagram depicting a variation of a better boarding order variation onto a two aisle two door airplane.

### DETAILED DESCRIPTION

The following detailed descriptions of embodiments are utilized applications and are not intended to limit the variations, use, application or embodiments of this method and system.

For the purpose of the following detailed description the terms better boarding order, standard boarding order and standard better boarding order are used interchangeably.

For the purpose of the following detailed description the term staggered formation is displayed as being staggered by one row. In other embodiments the term may be two or more rows as real time requirements deem to be most efficient.

For the purpose of the following detailed description the term call out is used to reflect the process of communicating the better boarding order with passengers. The call out may be directed through the use of interactive entertainment software to produce unique personalities to call out and display the better boarding order and interact with the passengers to progressively activate the better boarding. Communicating with boarding passengers may be facilitated through various other methods and are not limited to the methods described in the embodiments below.

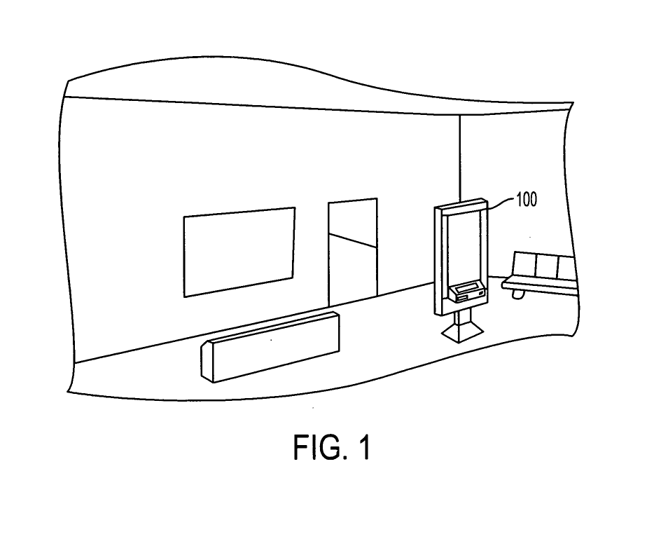

In one embodiment of the better boarding order a boarding machine (100) may be positioned in an airport gate and boarding lobby as in FIG. 1.

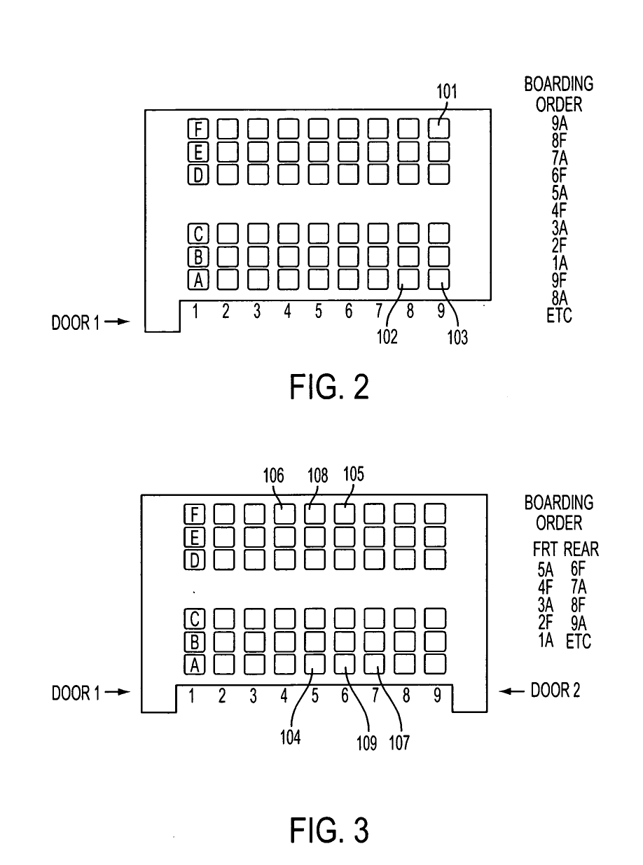

In one embodiment of a better boarding order where there is one door for boarding and one aisle as shown in (FIG. 2), a better boarding order may organize passengers to occupy their assigned seats starting from the rear of an airplane seating configuration (Row 9) progressing towards the front (Row 1). This embodiment organizes passengers to occupy their assigned seats in a staggered formation. The procedure starts from the assigned window seats furthest from the entry door, in the furthest assigned row (101-Seat 9F) progressing to an opposite assigned window seat of another row (102-Seat 8A) repeating until a front row seat is seated. The process will repeat starting at the seat opposite furthest assigned window seat (103-Seat 9A) until all assigned window seats are boarded. After which, the boarding of assigned middle seating passengers will progress in the same method until all assigned middle seating passengers are boarded. Concluding with the repeating of the method to board all assigned aisle seating passengers until all assigned passengers are boarded on the airplane.

In another embodiment of a better boarding order where there are two doors for boarding and one aisle (FIG. 3), a better boarding order may organize passengers to occupy their assigned seats starting from the center rows of the airplane seating configuration (104-Seat 5A and 105-Seat 6F) progressing towards the front (106-Seat 4F) and rear (107-Seat 7A). Organizing passengers to occupy their assigned seats in a staggered formation progressing towards the front and rear of the airplane till the last front and rear rows are seated. The process will repeat starting at the opposite center assigned window seat (108-Seat 5F and 109-Seat 6A) until all assigned window seats are boarded. After which, the boarding of assigned middle seating passengers will progress in the same method until all assigned middle seating passengers are boarded. Concluding with the repeating of the method to board all assigned aisle seating passengers until all assigned passengers are boarded on the airplane.

When boarding a particular vehicle, the method may utilize specific vehicle operations data and/or passenger data to dynamically facilitate passenger boarding. A non-exhaustive list of vehicle operations data may include seating configuration exit requirements and standard boarding order for said vehicle. A non-exhaustive list of passenger data may include unoccupied seats and passenger priority status for boarding. Passenger priority status may indicate passengers with special needs, passengers with children, elderly passengers, passengers that purchased boarding privileges or passengers that were rewarded with priority boarding privileges.

The better boarding system may be implemented on a computer. The computer is able to analyze the vehicle operations data, and determine and how to direct in real time the most effective and efficient way to board passengers by their assigned seats, according to the seating configuration and available entrance doors. The standard boarding order, organizes plane boarding by boarding passengers that are furthest away from the entry door first and the passengers closest to the entry door last. In this manner, passengers are less likely to obstruct or interfere with each other when getting to their seats and/or stowing luggage. The standard boarding order also organizes boarding so that typically one seat per row is assigned in a call out. The call out process is repeated where the row is filled one passenger at a time until the plane is fully boarded. The standard boarding order may or may not use a staggered formation where rows may be skipped in the call-out. The standard boarding order may also be dynamically modified to enable multiple passengers to board for particular rows. Multiple passengers may be required to board a particular row when a certain passenger(s) is unable to board the plane without assistance and/or supervision as in the case of sick, elderly, disabled and/or young passengers. Multiple passengers may also be boarded into a row in a single call out when a row is accessible by multiple aisles or as necessary as determined by the system.

Templates may be created that define the standard boarding order for directing of boarding passengers onto commercial airlines or passenger transporting vehicles. These templates may be modified in real time to create a real time boarding order.

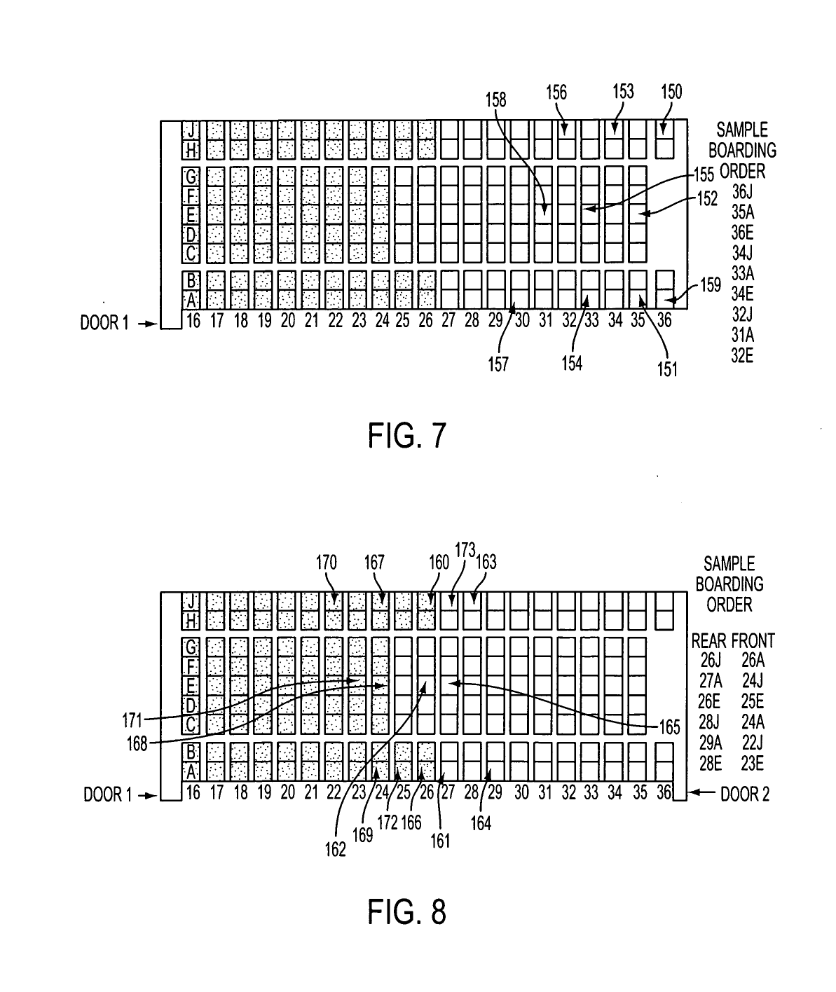

In one embodiment of a better boarding order where there is one door for boarding and two aisles, with a middle section as shown in (FIG. 7), a better boarding order may organize passengers to occupy their assigned seats starting from the rear of an airplane seating configuration (Row 36) progressing towards the front (Row 1). The better boarding order organizes passengers to occupy their assigned seats in a staggered formation. The better boarding order starts from one of the furthest assigned window seats in the furthest assigned row (150-Seat 36J), and progressively boards the opposite assigned window seat of another row (151-Seat 35A) and a seat in the middle section (152-Seat 36E). The better boarding order process repeats boarding a window seat (153-Seat 34J), the opposite assigned window seat of another row (154-Seat 33A) and a seat from the middle section (155-Seat 34E). The process is repeated as illustrated in the figure until a front row seat is seated. The process then will repeat starting at the seat opposite furthest assigned window seat (159-Seat 36A) until all assigned window seats are boarded. Concluding with the repeating of the method to board all assigned seating passengers until all assigned passengers are boarded on the airplane.

In another embodiment of a better boarding order where there are two doors for boarding and two aisles as shown in (FIG. 8), a better boarding order may organize passengers to occupy their assigned seats through the rear door starting from the center rows of the airplane seating configuration (160-Seat 26J, 161-Seat 27A and 162-Seat 26E) and progressing towards the rear (163-Seat 28J and 164-Seat 29A and 165-Seat 28E). While starting simultaneously from the center rows of the airplane seating configuration (166-Seat 26A and 167-Seat 24J and 168-Seat 25E) and progressing towards the front (169-Seat 24A and 170-Seat 22J and 171-Seat 23E). Organizing passengers to occupy their assigned seats in a staggered formation progressing towards the front and rear of the airplane till the last front and rear rows are seated. The process will repeat starting at the opposite center assigned window seat (172-Seat 25A and 173-Seat 27J) until all assigned window seats are boarded. Concluding with the repeating of the method to board all assigned aisle seating passengers until all assigned passengers are boarded on the airplane.

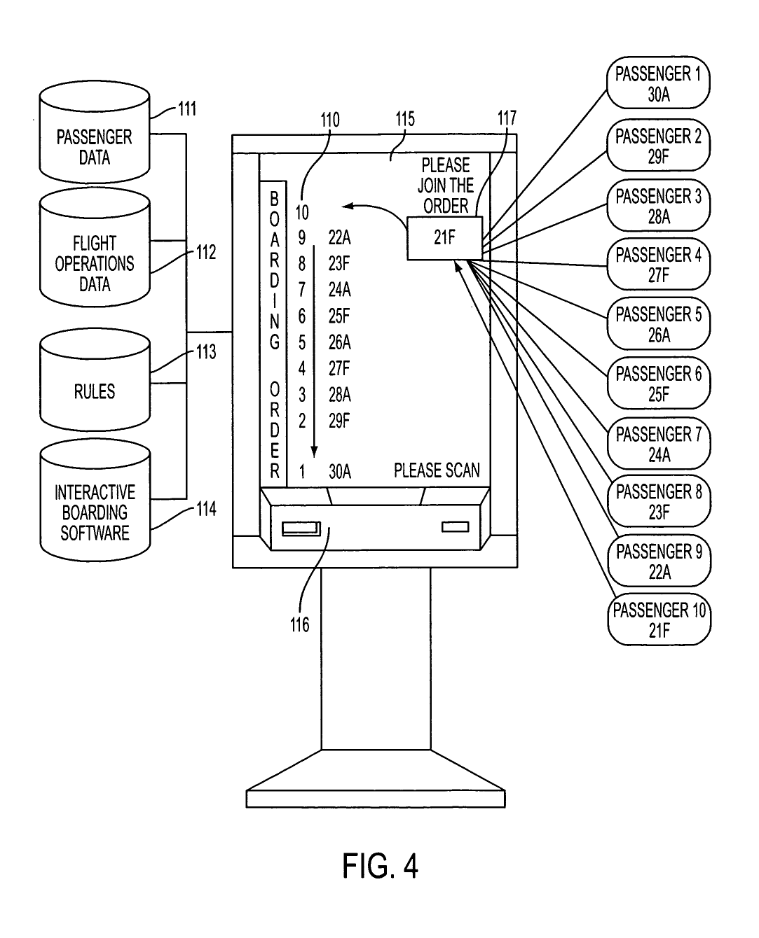

The above and other aspects of the mentioned embodiments may utilize seating configurations to build standard better boarding order. The better boarding system (FIG. 4) will build a standard better boarding order (110) utilizing passenger data (111) and flight operations data (112). The standard better boarding order may be modified in real time to accommodate the priority seating of passengers seated near exit and emergency doors utilizing rules (113).

The above and other aspects of the mentioned embodiments may utilize seating configurations to build a standard better boarding order. The better boarding system (FIG. 4) will build a standard better boarding order (110) utilizing passenger data (111) and flight operations data (112). The standard better boarding order may be modified in real time to accommodate passenger boarding priorities as designated by airline or operator offers, program benefits or by preferred priority class as determined by the airline or operator rules (113).

The above and other aspects of the mentioned embodiments may utilize seating configurations to build a standard better boarding order. The better boarding system (FIG. 4) will build a standard better boarding order (110) utilizing passenger data (111) and flight operations data (112). The standard better boarding order may be modified in real time to accommodate the priority seating of passengers who purchased priority boarding privileges utilizing the interactive software (114).

In FIG. 4, the passenger may be educated and entrained by the interactive video display (115) on how to participate in a better boarding prior to the boarding of the airplane. The passenger may also be provided with promotional videos, details and tips for the scheduled flight and destination.

In FIG. 4, passengers may purchase priority boarding for the flight utilizing the interactive panel (116) on the boarding machine which would instantly update flight data and trigger the system to update the interactive boarding software (114) to update the real time boarding order (110).

In FIG. 4, passengers may be guided by the interactive boarding software (114) to utilize the interactive panel (116), by scanning or touch a touch pod, to confirm boarding of the airplane and thereby activate the interactive boarding software (114) to progress the real time boarding order and call out and/or display the next passenger to join the boarding order (117).

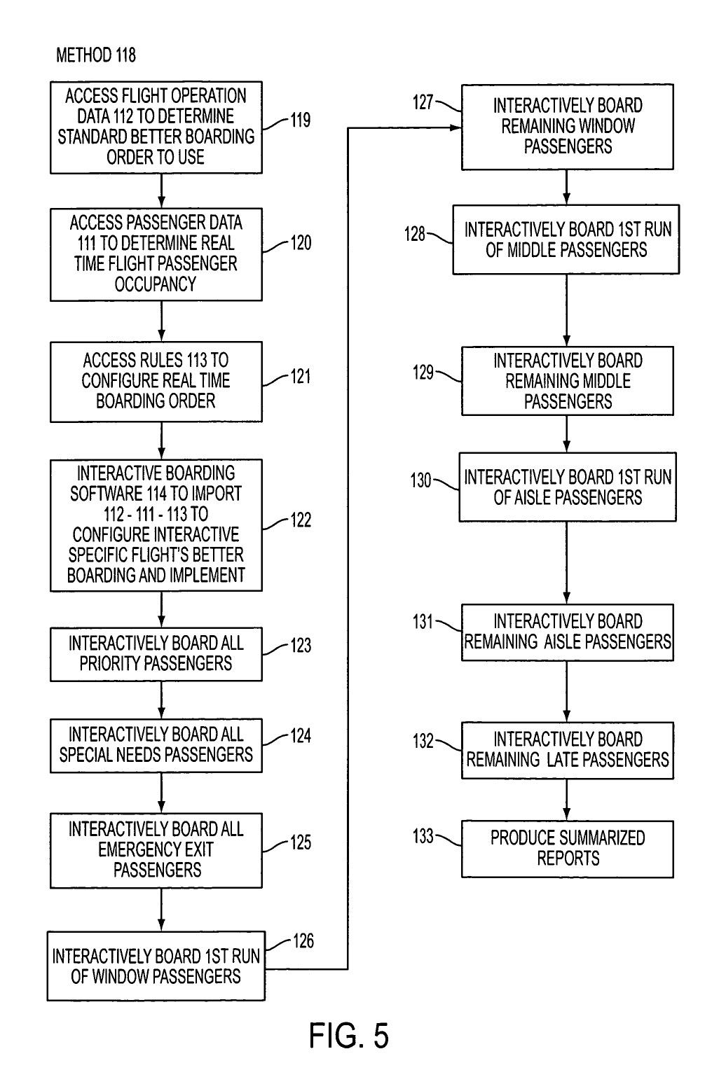

A method (118) in accordance with one of the embodiments is shown in (FIG. 5). The method may begin in step (119) in which the system accesses flight operation data (112) to determine which standard better boarding order to use. In step (120) the system accesses the real time passenger data (111) to determine flight passenger occupancy. After steps (119) and (120) are entered, the system progresses to step (121). Rules (113) are accessed to apply standard, special and purchased priorities. In step (122) the interactive boarding software (114) configures the flight's unique dynamic assembled data to produce the flight's specific interactive better boarding order for implementation. In step (123) priority passengers are called and interact with the machine (116) to systematically and progressively board the airplane. In step (124) special needs passengers are directed to interact with the machine (116) to systematically and progressively board the airplane. In step (125) emergency and exit passengers are called and interact with the machine (116) to systematically and progressively board the airplane. In step (126) the 1ₛₜ run of window passengers are directed to interact with the machine (116) to systematically and progressively board the airplane. In step (127) remaining window passengers are directed to interact with the machine (116) to systematically and progressively board the airplane. In step (128) the 1st run of middle passengers are directed to interact with the machine (116) to systematically and progressively board the airplane. In step (129) remaining middle passengers are directed to interact with the machine (116) to systematically and progressively board the airplane. In step (130) 1st run of aisle passengers are directed to interact with the machine (116) to systematically and progressively board the airplane. In step (131) remaining aisle passengers are directed to interact with the machine (116) to systematically and progressively board the airplane. In step (132) remaining late passengers are directed to interact with the machine (116) to systematically and progressively board the airplane. In step (133) the system produces summary reports. In the case of passengers who unknowingly or intentionally attempt to hop in line, the rules (113) will politely advise the incorrect call out was presented and proceed to repeat the designated direction or call out.

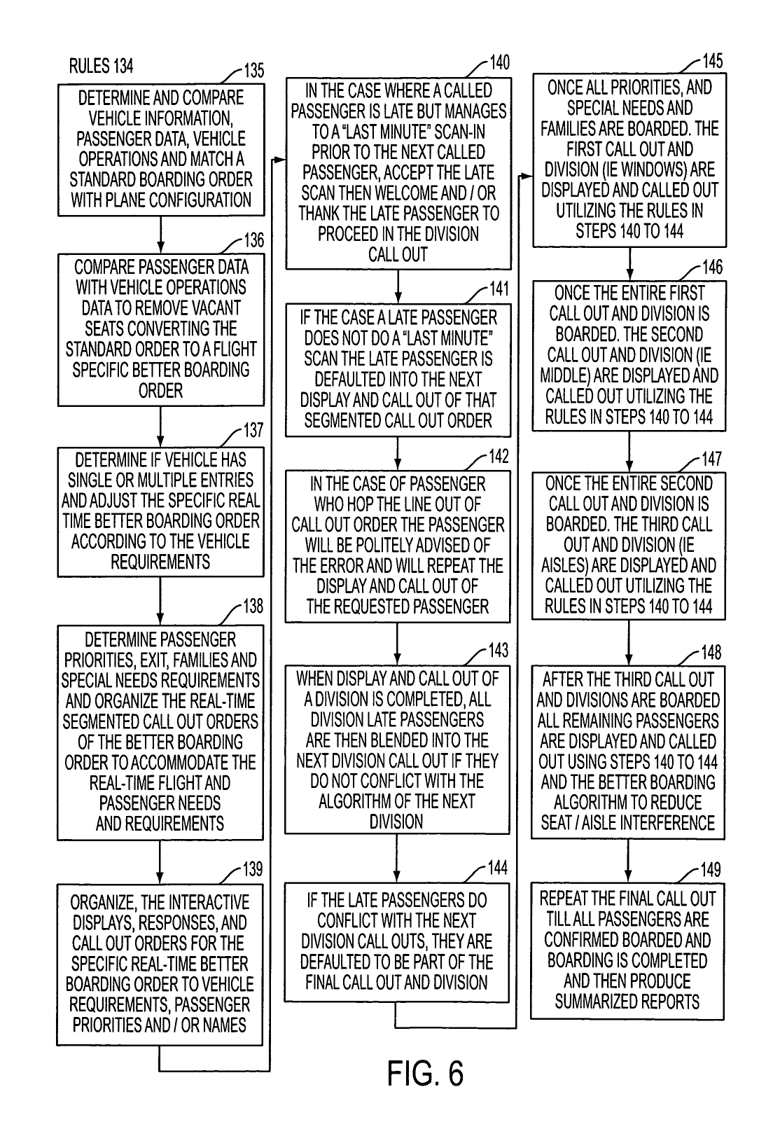

In FIG. 6 a diagram is used to demonstrate one embodiment of rules (134). The system can utilize a real time better boarding order to organize and direct the Better Boarding through a better boarding system. In step (135) passenger data and flight operations data are compared with the standard predesigned boarding order for the plane seating configurations. In step (136) passenger data and flight operations data are compared with the better boarding order to remove vacant seats and convert the standard better boarding order into a flight specific better boarding order. In step (137) the system rules determines the whether, either single door or dual door entry into the airplane are possible and adjusts the specific real time boarding order accordingly. In step (138) the system rules adjusts the specific real time boarding order to accommodate all the dynamic parameters of the flight. In step (139) the system organizes the flight specific real time boarding order according to passenger priorities, emergency exits, special needs and families. In step (140) the system rules allow for late passengers who do a “last minute” scan before the next called out passenger scans. In step (141) late passengers who fail to do a “last minute” scan are defaulted to be called out and displayed in the next division. In step (142) passenger who attempt to hop in line are politely notified of the error and repeats the call out of the requested passenger. In step (143) the rules allow for all non conflicting late passengers to be called out in the next call out division. In step (144) system rules organize conflicting late passengers that conflict with the standard call outs. These late passengers are defaulted and organized into a final call out and division using the standard better boarding algorithm to complete the vehicle boarding. In step (145) system rules move into the call out of segments and divisions starting with the call out of the first segment (IE windows) of boarding passengers applying step (140) to (144) to the call out and division. In step (146) the first call out of the second segment, (IE middle seats) are displayed and called out to board utilizing steps (140) to (144). In step (147) the first call out of the third segment, (IE aisle seats) are displayed and called out to board utilizing steps (140) to (144). In step (148) the final segment call outs and division are displayed and called out to board the flight to complete the better boarding. In step (149) the boarding is completed and the system produces summarized reports.

The following advantages of the better boarding order method and the better boarding system are presented to reflect the advantages within the embodiment of the airline industry and are not limiting to the scope of industries these advantages and others may be applied. They are as follows: 1) The unsolved critical requirement needed to capitalize on the findings of many of the boarding studies,which demonstrate boarding by assigned seats to be optimal, is now resolved. 2) Passenger boardings are hosted and directed at the gate, reducing lobby and gate anxiety. 3) Passengers are efficiently and respectfully boarded with dynamic interactive entertainment software, according to their priority and assigned seat, improving passenger service. 4) Aisle and seat interferences of present boarding methods are substantially reduced minimizing cabin anxiety and passenger stress. 5) Airplane turn times and subsequently costs are reduced. 6) Airlines can communicate with passengers at the gate to better inform passengers of real time flight status and other trip information. 7) Airlines can interactively educate passengers how to participate in the efficient boarding of the vehicle to improve passenger boarding experiences. 8) Passengers can conveniently upgrade their boarding priority by purchasing priority boarding at the gate. 9) Passengers can conveniently purchase optional items and services without the present crowded environment of the plane, improving passenger travel experiences. 10) Passengers can use credit cards to make at the gate purchases and receive a receipt. 11) Airlines will have an at the gate point of sale (POS) to develop new services and multiple ancillary revenues. 12) Airlines will have an at the gate system to better monitor and measure airplane boardings to progressively improve boarding efficiencies and enhance passenger experiences. 13) Airlines will have an at the gate system to customize and personalize every boarding, to develop greater passenger affinities. 14) Passengers can utilize airline rewards at the gate to purchase items and services.

This method and system can be embodied in other forms and other equipment without departing from the spirit or essential attributes thereof and, as such, references be directed to the following claims rather than the foregoing specifications as indicating the scope of the method and system.

1. A computer implemented method of organizing and directing the boarding of passenger onto a passenger transporting vehicle for a trip comprising of the following steps:
determining the vehicle operations data for said vehicle;
determining the passengers data for the said boarding; and
organizing the interactive call out of a dynamic real time boarding order of passengers for said vehicle and said trip using said vehicle operations data and said passenger data.

2. The method of claim 1, wherein said vehicle operations data comprises the seating configuration exit requirements for the said vehicle.

3. The method of claim 1, wherein said vehicle operations data comprises a standard boarding order for said vehicle.

4. The method of claim 1, wherein said passenger data comprises the unoccupied seats for the said trip.

5. The method of claim 1, wherein said passenger data comprises the passengers priority status for the said boarding.

6. The method of claim 5, wherein said passenger priority status comprises passengers with special needs for the said boarding.

7. The method of claim 5, wherein said passenger priority status comprises passengers with children for the said boarding.

8. The method of claim 5, wherein said passenger priority status comprises passengers that purchased priority boarding privileges for the said boarding.

9. The method of claim 5, wherein said passenger priority status comprises passengers rewarded with priority boarding privileges the said boarding.

10. The method of claim 3, wherein said standard boarding order comprises:
seating passengers according to their assigned seats;
seating passengers rear to front;
seating passengers one passenger in one row at a time;
seating passengers in rows with one or more vacant row(s) between seating rows;
seating passengers starting with furthest seating window passengers from the designated entry door, and when applicable, middle seating passengers of a center section, first:
seating passengers progressively, staggered, on opposite sides of the said vehicle at the same time;
boarding the vehicle in segmented call out orders and displays until the said boarding is complete.

11. The method of claim 10, wherein said segmented call out orders comprises of said call out order and division such as;
Call out 1, division a) comprising window seating passengers, and when applicable, middle seating passengers of center sections;
Call out 1, division b) comprising remaining window seating passengers, and when applicable, middle seating passengers of center sections; to complete the said dynamic real time boarding of said vehicle.

12. The method of claim 10, wherein said displays comprises of electronically showing said passengers the said real time boarding order by assigned seat and or said passenger by name.

13. The method of claim 1, wherein said organizing step comprises comparing vehicle operations data and passenger data.

14. The method of claim 1, wherein said interactive call out comprises of a machine audibly acknowledging said passenger confirming boarding to activate the progressive directing of the said real time boarding order.

15. The method of claim 1, wherein said dynamic real time boarding order comprises the application of rules.

16. The method of claim 14, wherein said passengers confirming boarding comprise passengers scanning their boarding pass.

17. The method of claim 14, wherein said passengers confirming boarding comprise passengers scanning their required proof of identification.

18. The method of claim 14, wherein said passengers confirming boarding comprise passengers physically interacting with machine.

19. The method of claim 14, wherein said passengers confirming boarding comprise passengers interacting with wireless devices.

20. The method of claim 14 wherein said progressive directing comprises said passengers only boarding when said passenger is called out one said passenger at a time according to the said real time boarding order.

21. The method of claim 15, wherein said rules comprise the real time formulating of said dynamic real time boarding order for said vehicle and trip according to said vehicle operations data, said passenger data and said passenger confirming boarding.

22. A computer implemented method to build universal standard boarding order templates for passenger transporting vehicles that can be converted into said real time boarding orders for said directing of boarding passengers onto said passenger transporting vehicle in real time.

23. A system for directing the real time boarding of a passenger transporting vehicle comprising a machine for;
storing vehicle operations data, passenger data and standard boarding order;
real time boarding order;
communicating with said passengers prior to boarding;
facilitating passenger purchases at the gate communicating said dynamic real time boarding order;
communicating with said passengers during the boarding;
interacting with real time participating boarding passengers;
progressively boarding passengers as passengers confirm participation in real time; and
producing boarding session reports after all boarding passengers confirmed participation and completed the said real time boarding.

24. The system of claim 23, wherein communicating comprise interactive entertainment software.

25. The system of claim 23, wherein communicating comprises audio.

26. The system of claim 23, wherein communicating comprises video.

27. The system of claim 23, wherein communicating comprises touch screen.

28. The system of claim 23, wherein communicating comprises wireless devices.

29. The system of claim 23, wherein facilitating passenger purchases comprise accepting credit card payments for purchases.

30. The system of claim 23, wherein facilitating passenger purchases comprise providing receipts for purchases.

31. The system of claim 23, wherein facilitating passenger purchases comprise accepting reward plan points as payment for purchases.

32. The system of claim 23, wherein interacting with passenger comprise responding to said passenger real time participation.

33. The system of claim 23, wherein a machine comprises;
a means of displaying vehicle information;
a means of scanning;
a means of entering data;
a means of playing audio;
a means of processing credit card payments;
a means of processing reward plan points; and
a computer to produce a real time boarding order, direct the real time boarding order, interact with said passengers and complete the said real time boarding of said vehicle.
